(19) United States
(12) Patent Application Publication
(10) Pub. No.: US 2025/0130961 A1
(43) Pub. Date: Apr. 24, 2025

(54) INFRASTRUCTURE INDEPENDENT SELF-CONFIGURING MANAGEMENT NETWORK

(71) Applicant: STRATUS TECHNOLOGIES IRELAND LTD., Dublin (IE)

(72) Inventor: Charles Horvath, Jamaica Plain, MA (US)

(73) Assignee: STRATUS TECHNOLOGIES IRELAND LTD., Dublin (IE)

(21) Appl. No.: 18/399,493

(22) Filed: Dec. 28, 2023

Related U.S. Application Data
(60) Provisional application No. 63/545,153, filed on Oct. 20, 2023.

(51) Int. Cl. G06F 13/20

(52) U.S. Cl. CPC G06F 13/20; G06F 2213/40

(57) ABSTRACT

a first input/output (IO) module and a computer system including a first processor, a first computer system including a first processor, a first memory, a first operating system, a first baseboard management controller (BMC), a first network controller, and a management network including a set of network endpoints wherein each network endpoint has a first address, wherein each network endpoint is an internal device connected to the management network, and wherein the first operating system is interfaced with the first BMC through a first interface supported by the first BMC.

### CROSS REFERENCE TO RELATED APPLICATIONS

This application is a U.S. patent application which claims priority to and the benefit of U.S. Provisional Patent Application No. 63/545,153, filed on Oct. 20, 2023.

### FIELD

The disclosure relates generally to an architecture for a computer system and more specifically to self-configuring management networks.

### BACKGROUND

For various computer systems, when setting up a network it is typically the case that a user must manually configure various addresses for devices that are part of the network or alternatively set up external infrastructure such as a DHCP server. In addition to being a laborious process, for various implementations, a user may have its own internal network and be using a third party computing system that has its own networks that must operate relate to such user's network. As a result, there can be circumstances in which a user network can be compromised or otherwise negatively impacted as a result of the use of the third party computing system. The present disclosure addresses these problems and others.

### SUMMARY

In part, in one aspect, the disclosure relates to a computing system. The computer system includes a first input/output (IO) module and a computer system including a first processor, a first computer system including a first processor, a first memory, a first operating system, a first baseboard management controller (BMC), a first network controller, and a management network including a set of network endpoints wherein each network endpoint has a first address, wherein each network endpoint is an internal device connected to the management network, and wherein the first operating system is interfaced with the first BMC through a first interface supported by the first BMC.

In one embodiment, the first interface supported by the first BMC is a keyboard controller style (KCS) or Inter-Integrated Circuit (I2C) based Intelligent Platform Management Interface (IPMI) wherein each first address is a defined address. In another embodiment, each first address is a media access control (MAC) address. In some embodiments, each endpoint has a second address derived from the first address, wherein the second address is a link local address. In some embodiment, each first address is a IPv6 link-local address.

In some embodiments, the first network controller, the first IO module, and the first BMC are each an internal device connected to the management network. In one embodiment, the system further includes a second IO module and a second computer system including a second processor and a second memory, a second operating system, a second BMC, a second network controller, wherein the first computer system and the second computer system are linked by a sideband communication channel, wherein the sideband communication channel supports the first computer system and the second computer system exchanging one or more addresses. In another embodiment, the second Ethernet controller, the second IO module, and the second BMC are each an internal device connected to the management network. In some embodiments, each first address is a media access control (MAC) address. In some embodiments, each first address is a IPv6 link-local address.

In some embodiment, the first operating system is interfaced with the first BMC through a first interface supported by the first BMC, wherein the second operating system is interfaced with the second BMC through a second interface supported by the second BMC. In some embodiments, the first interface and the second interface are both KSC or I2C based IPMI interfaces. In one embodiment, the one or more addresses is an address of: a first computer system, the second computer system, or address of both the first computer system and the second computer system. In another embodiment, the first operating system includes a management virtual machine and a virtual switch, wherein the second operating system includes a teaming interface interfacing with one or more teamed connections and one or more non-teamed connection.

In another aspect, the disclosure relates to a method of allocating addresses in a self-configuring management network. The method including connecting a plurality of endpoints of a management network, exchanging a first address between a first endpoint of the plurality of endpoints and a second endpoint of the plurality of endpoints, determining a second address, the second address derivable form the first address, the second address associated with the first computer system, and transmitting the second address to the second computer system using a sideband communication channel such that the second computer system can communicate with one or more devices of the first computer system.

In some embodiments, the first address is a MAC address and the second address is a IPv6 link local address. In another embodiment, the step of determining the second address includes querying a BMC to obtain the first address and thereby deriving the second address. In one embodiment, the BMC is queried by an operating system using a KCS or I2C based IPMI, the operating system running on one of the end points.

In one embodiment, determining the second address includes accessing one or more scratchpad registers of one or more PCI switches and further includes populating one or more scratchpad registers to exchange the first address for each endpoint of the plurality of endpoints using the sideband communication channel. In one embodiment, the method further includes deriving a second address from each first address, wherein the first address is a MAC address and the second address is a IPv6 link-local address. In some embodiments, configuring the plurality of endpoints is performed automatically without user configuration of any first addresses or second addresses. In one embodiment, the sideband communication channel is a Peripheral Component Interconnect-based communication channel.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation.

### BRIEF DESCRIPTION OF THE DRAWINGS

The structure and function of the disclosure can be best understood from the description herein in conjunction with the accompanying figures. The figures are not necessarily to scale, emphasis instead generally being placed upon illustrative principles. The figures are to be considered illustrative in all aspects and are not intended to limit the invention, the scope of which is defined only by the claims.

FIG. 1 is a block diagram of a high reliability fault tolerant computer system with a management network in accordance with an exemplary embodiment of the disclosure.

FIG. 2 shows an alternative representation of the computer system in FIG. 1 in accordance an exemplary embodiment of the disclosure.

### DETAILED DESCRIPTION

Modern computer systems often have a network dedicated to management of the computer system which is separate from the system's production network. In many computer systems the management network is used for both internal communication between the system components and external (end-user) access to management functions.

Current management network implementations have limitations. First, the configuration of the management network on the user's part can be required prior to the management network being usable for internal communication. Second, misconfigurations of the management network—like incorrectly inputting an IP address—can render the management network to be unusable for internal communication. Third, a malfunction or misconfiguration of a user network infrastructure—a failed DHCP or DNS servicer—can also cause the management network to be unusable for internal communications.

The present disclosure provides a management network infrastructure that is self-configuring. That is, the network does not require user configuration to be usable for internal purposes and the internal use is independent of use configuration or infrastructure. In addition, the management network may be used with a computing system that interfaces with a customer's network, but is configured such that the computing system does not interfere with the customer's network and vice versa.

In some embodiments, the systems and methods disclosed herein may accomplish this by using a self-configuring address. The self-configuring address may be a IPv6 link-local addressing for internal communication and exchanging the MAC addresses of internal components needed for determining IPv6 link-local addresses through non-network based channels. In several embodiments, other self-configuring addresses may be used. Various system and methods embodiments relating to self-configuring management network architecture implementation are disclosed herein. The self-configuring network related embodiments prospectively operate to avoid various problems and failure modes that may result from various network or address misconfigurations.

Computer systems often have management networks. Management networks are one or more networks configured to monitor and/or control a computer system that is distinct from the one or more networks carrying production traffic generated and received by end-user applications running on the computer system. In various embodiments, the network is redundant, that is, there are two separate physical networks, a first Management Network and a second Management Network.

Computer systems and management networks take on a variety of different forms. For example, the computer system can be composed of multiple nodes with their own input/output (IO) module and operating system within a chassis with wired management network connecting each node. The present disclosure may also span multiple chassis with the wired management network connecting the nodes in all the chassis. It may also have additional devices on the management network such as processor(s) dedicated to control, environmental monitoring, or display of system status. These systems may have additional devices on the management network such as network switches. These systems can have nodes wherein each node contains primarily computing capabilities, primarily storage capabilities, or primarily IO capabilities. These systems may run virtualized operating systems on individual nodes or on a combination of nodes.

Management networks also exist on other systems. For example, software defined network infrastructure has the concept of a control plane and data plane where the control plane resides on a dedicated management network district from data plane carrying the end user application data.

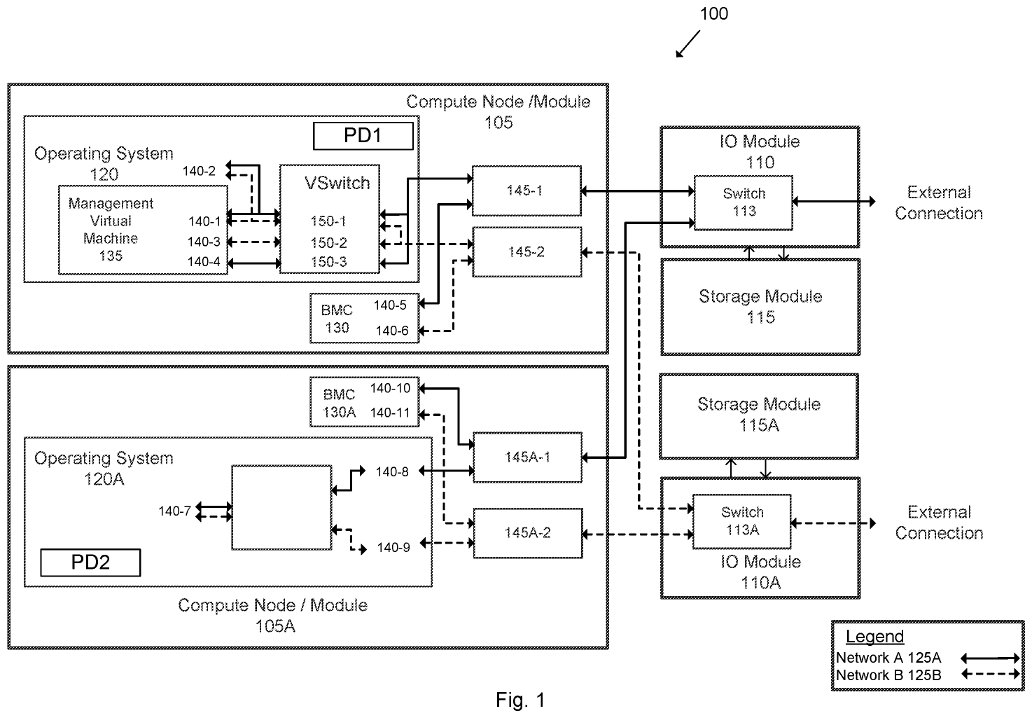

Refer now to the exemplary embodiment of FIG. 1. FIG. 1 shows a high reliability fault tolerant computer system 100 with a management network. This system 100 has redundancy built into the management network so that the management network remains functional even if a component fails. For example, the system disclosed in FIG. 1 is a multi-module computer system. It includes a first and second compute node 105, 105A, a first and second IO module 110, 110A, and a first and second storage module 115, 115A. The management network is represented by the arrows that connecting various components. In some embodiments, the storage module may include one or more disks or other computer-readable electronic data storage device.

In this embodiment the compute nodes/modules 105 each include one or more processors and memory and also include an operating system 120, 120A. The operating systems 120 are run by a processor/memory subsystem. In various embodiments, the operating systems 120 are Windows, Linux, VMware ESX or another operating system. The IO Modules 110 include the production networking used by the operating systems 120A, 120. In various embodiments, the IO modules 110 include network switches 113, 113A. The storage modules 115 may include the storage used by the operating systems. In various embodiments, the operating system 120, 120A running on the two compute nodes may include a platform driver PD1, PD2.

In various embodiments, the platform driver may identify devices, memory associated with device, addresses associated with devices and various sideband or other communication channels, such as for example one of PCI bridges or busses. The platform driver PD1 may exchange information from a first compute node or module such as module 105 with a second compute node or module such as module 105A. The platform driver PD2 may exchange information from a first compute node or module such as module 105A with a second compute node or module such as module 105. In some embodiments, this information communicated by a platform drive between compute nodes includes one or more addresses such as self-configuring addresses or derivable addresses relating to components of a given computer node. Various references to compute nodes and compute modules may also include a computer system generally or a collection of components thereof.

In various embodiments, the components utilizing the management network for communications include multiple operating systems 120 running on the compute modules 105; baseboard management controllers (BMCs) 130, 130A on the management controllers; and a management virtual machine 135 running on one of the operating systems executing on one of the compute modules 105. The BMCs 130 are independent embedded processors which provide a number of management functions such as environmental monitoring (e.g. system temperature), remote keyboard/video, remote media capabilities, and remote power control.

In some embodiments, the management virtual machine 135 oversees the management of the system and utilizes the management network for communicating with the BMCs to gather and process environmental monitoring information, communicating with the operating systems to monitor the network, storage, memory usage, and other parameters, and host a web interface utilized by external entities for managing and monitoring the system.

In various embodiments, the compute modules include a plurality of Ethernet controllers 145-1, 145-2, 145A-1, 145A-2 that are utilized in the management network. In various embodiments, one or more of the Ethernet controllers are I210-IS controllers. Other network controllers and networking protocols may be used.

For redundancy, the management network is composed of two physical instances. The redundant management networks 125A, 125B provide network connectivity between network components and external components such as a desktop computer accessing a management user interface hosted on the computer system. Teamed OS network interfaces support access to and from either management network instance, while non-teamed OS network interfaces support access to and from just the management network they are connected to. In some embodiments, a teamed configuration or a network bond configuration may be used load balancing or hot standby services for multiple network ports being treated as a single network port.

The redundant management networks connect a plurality of endpoints 140-1, 140-2, etc. (without limitation) with IP addresses. The operating system 120 on the first compute module 105 includes a teamed interface to the management virtual machine 135, 140-1; a teamed interface to the kernel of operating system 120, 140-2; a non-teamed interface to the management virtual machine 135 on the management network B 125B, 140-3; and a non-teamed interface to the management virtual machine 135 on management network A 125A, 140-4. The first compute module 105 also includes a non-teamed interface to BMC 130 on management network A 125A, 140-5; and a non-teamed interface to BMC 130 on management network B 125A, 140-6.

The operating system 120A on the second compute module 105A includes a teamed interface 140-7 to the operating system 120A; a non-teamed interface 140-8 to the operating system running 120A on management network A 125A; and a non-teamed interface 140-9 to the operating system running 125A on management network B 125B. The second compute module 105A also includes a non-teamed interface 140-10 to BMC 130A on management network A 125A; and a non-teamed interface 140-11 to BMC 130A on management network B 125B. In various embodiments, the references to teamed and non-teamed interface all may be identified as an interface or interface without any limitation or requirements relating to teaming or non-teaming.

In various embodiments, the management network also involves the VSwitch of the operating system 120. In various embodiments, the VSwitch includes a plurality of port groups, 150-1, 150-2, 150-3. In various embodiments, the first port group 150-1 is a teamed interface that supports access to both Network A 125A and Network B 125B. In various embodiments, the second port group 150-2 and third port group 150-3 are non-teamed interfaces that support access to Network B 125B and Network A 125A respectively.

In various embodiments, the system 100 is configured for internal use. For internal use cases, the system management software internal to the computer system utilizes the management network for communicating between internal components. For example, the software on the management virtual machine 135 communicating with the BMCs 130 to monitor machine environmental or initiating computer system operations such as power off. Additionally, the software on the management virtual machine 135 may communicate with software on the operating system 120A on the second compute module 105A to ascertain the health of that operating system 120A. Further, the software from the management virtual machine 135 may communicate with the software on the underlying compute module 105 to determine its operation system 120 health. A person of skill in the art would appreciate additional internal uses.

In various embodiments, the system 100 is configured for external communications. For external communications use, external computers (e.g. a desktop PC), utilizes the management network to communication with internal components. An external computer may access a web interface hosted on the management virtual machine 135 that provides information on the health of the system and permits control of the system. An external computer may also access a REST or other API hosted on the management virtual machine 135 that provides information on the health of the system and permits control of the system. An external computer may also access one or both BMCs for the purpose of mounting remote media or executing a remove KVM session. Further, the management virtual machine 135 or a BMC 130 may send an external computer SNMP traps, email alerts, or other notifications to indicate computer system status. The computer systems and related communication systems external communication uses.

In various embodiments, because the management networks 125A, 125B can be used to communicate with external entities, the internal network endpoints such as, for example, 140-1, 140-2, 140-3, . . . , etc. may be configured by the end user for use on the end use network. The IP addresses, gateways, netmasks, and DNS may require configuration by the end user, or alternatively, the end user must configure and supply a DHCP server.

Existing management network implementations often encounter problems when there is a misconfiguration on the management network or failure of an external component on the management network (e.g. a DHCP server) which can break use of the management network, and therefore internal system monitoring/control.

The present disclosed decouples internal use of one or more management networks from user misconfiguration and failure of use infrastructure by utilizing IPv6 link-local IP addresses for internal management network communication. IPv6 link-local addresses are derived from the interface's MAC address and hence require no configuration. IPv6 link-local addresses are present on any network device which supports IPv6 and are in addition to and independent of the user defined IPv4 and/or IPv6 network configuration parameters.

Generally, IPv6 requires that the various internal endpoints on the management network determine each other's IPv6 link-local addresses, or alternatively, each other's MAC address from which the IPv6 link-local address can be derived. The present disclosure uses alternative, non-network interfaces for exchanging MAC addresses between the internal endpoints on the management network for this purpose.

In various embodiments, the BMCs 130 support a I2C (Inter-Integrated Circuit) or KCS (keyboard controller style) based Intelligent Platform Management Interface (c) between the operating system 120 on each compute module 105 and its local BMC 130. Each operating system 120 can use the interface to query a local BMC 130 for its MAC addresses, thereby deriving the BMCs IPv6 link-local addresses. In some embodiments, a given BMC may be a first interface (or other enumerate interface second, third, etc.) that is interfaced with through the IPMI to obtain a self-configuring address or an address from which a self-configuring address may be derived.

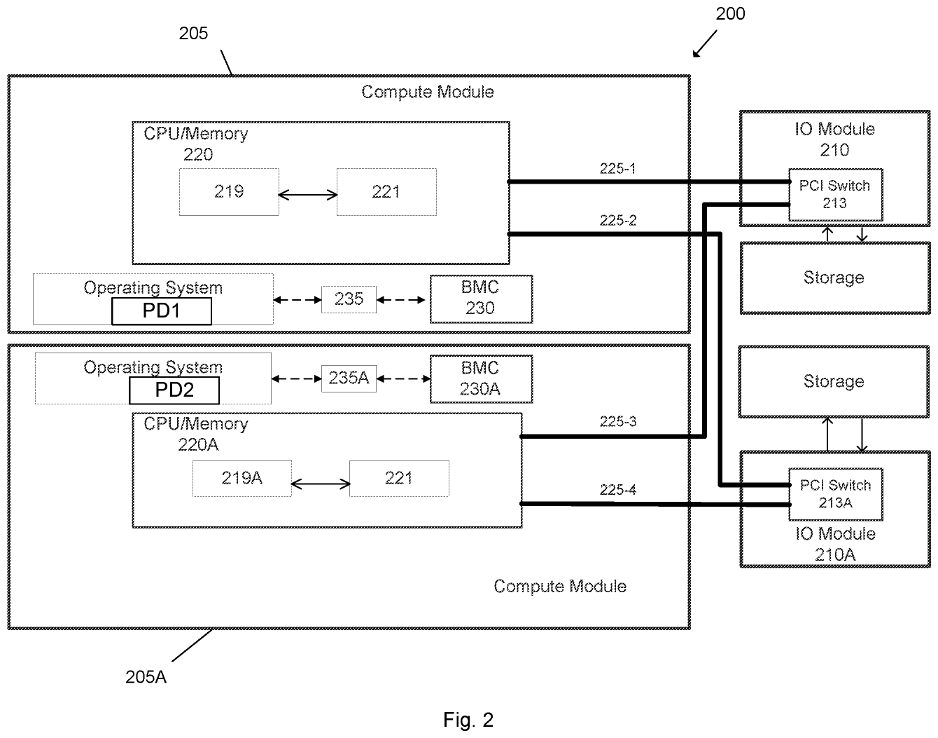

Refer now to the exemplary embodiment of FIG. 2. FIG. 2 provides an alternative representation of the computer system in FIG. 1. FIG. 2 a high reliability fault tolerant computer system 200 with PCI busses 225-1, 225-2, 225-3, 225-4, which connect the compute module 205, 205A to PCI switches 213, 213A on the IO modules 210, 210A instead of illustrating the management network as in FIG. 1. Each compute module/node 205, may include a processor and memory 220, 220A subsystem that runs an operating system and includes a processor 219, 219 and memory 221, 221A. The PCI switches 213 contain scratchpad registers accessible via an operation system platform driver PD1, PD2 on each compute module 205, 205A that the operating systems can exchange each other's MAC addresses, thereby permitting them to derive each other's IPv6 link-local addresses (self-configuring addresses) for each compute module/node 205A, 205 for the computer system 200. In various embodiments, multiple computer systems and multiple compute modules/nodes can be used without limitation. In some embodiment, with regard to system 200 of FIG. 2 and other system embodiments, a given BMC may have a local interface such as an IPMI interface 235, 235A that connects or otherwise is configured to allow the BMC 235, 235A to communicate with the operating system. In some embodiments, the IPMI interface may be an IPMI KCS, an I2C Interface or other suitable IPMI-based interfaces for connecting the BMC to an Operating System.

In various embodiments, all internal management endpoints are able to directly or indirectly determine the IPv6 link-local addresses for all the other internal management network endpoints prior to any internal use of the management network. Once this is done, all internal endpoints can communicate with each other via IPv6 link-local addresses. This connectivity is independent on any customer network configuration.

Although the disclosure is not limited to fault tolerant computing systems, there are some advantages for implementing the self-configuring management network features disclosed herein in such a system. In a fault tolerant system, some of the advantageous fault tolerance may arise from being able to configure a system or network for fault tolerant operation, generally to support hot swapping a new device, system or component for a failing system or expanding or changing a given computer system by inserting or adding a component during system operation (hot insertion). When a device, component, or system is replaced, added, or initially configured, its address information may be obtained to populate and support a given management network. As a result, each time a device is replaced or added, for example, the self-configuring processes that may use a BMC and an Intelligent Platform Management Interface to automatically assign addresses to various components of a computer modules may be implemented. In addition, a sideband channel such as a PCI bridge may be used with an operating system platform drive to exchange the management network addresses for each compute node/computer system and complete the identification of the addresses of the endpoints or nodes of one, two or more management networks. In various embodiments, the platform driver is a kernel mode driver.

Unless specifically stated otherwise as apparent from the following discussion, it is appreciated that throughout the description, discussions utilizing terms such as “processing” or “computing” or “calculating” or “delaying” or “comparing”, “generating” or “determining” or “forwarding or “deferring” “committing” or “interrupting” or “handling” or “receiving” or “buffering” or “allocating” or “displaying” or “flagging” or Boolean logic or other set related operations or the like, refer to the action and processes of a computer system, or electronic device, that manipulates and transforms data represented as physical (electronic) quantities within the computer system's or electronic devices' registers and memories into other data similarly represented as physical quantities within electronic memories or registers or other such information storage, transmission or display devices. In some embodiments, reference to first, second, third, fourth, etc. may be used to enumerate any of the components, devices, modules, nodes, etc. that are described and depicted herewith without limitation and without being held to particular limitation (a component may be a first component and in another embodiment the same component may be referenced as a second component and vice versa).

The algorithms presented herein are not inherently related to any particular computer or other apparatus. Various general purpose systems may be used with programs in accordance with the teachings herein, or it may prove convenient to construct more specialized apparatus to perform the required method steps. The required structure for a variety of these systems is apparent from the description above. In addition, the present disclosure is not described with reference to any particular programming language, and various embodiments, may thus be implemented using a variety of programming languages.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

The examples presented herein are intended to illustrate potential and specific implementations of the present disclosure. The examples are intended primarily for purposes of illustration of the disclosure for those skilled in the art. No particular aspect or aspects of the examples are necessarily intended to limit the scope of the present disclosure.

The figures and descriptions of the present disclosure have been simplified to illustrate elements that are relevant for a clear understanding of the present disclosure, while eliminating, for purposes of clarity, other elements. Those of ordinary skill in the art may recognize, however, that these sorts of focused discussions would not facilitate a better understanding of the present disclosure, and therefore, a more detailed description of such elements is not provided herein.

The processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media. In various embodiments, a “host,” “engine,” “loader,” “filter,” “platform,” or “component” may include various computers or computer systems, or may include a reasonable combination of software, firmware, and/or hardware.

In various embodiments, of the present disclosure, a single component may be replaced by multiple components, and multiple components may be replaced by a single component, to perform a given function or functions. Except where such substitution would not be operative to practice embodiments of the present disclosure, such substitution is within the scope of the present disclosure. Any of the servers, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it may be apparent to one of ordinary skill in the art that various embodiments, described herein, or components or parts thereof, may be implemented in many different embodiments of software, firmware, and/or hardware, or modules thereof. The software code or specialized control hardware used to implement some of the present embodiments is not limiting of the present disclosure. Programming languages for computer software and other computer-implemented instructions may be translated into machine language by a compiler or an assembler before execution and/or may be translated directly at run time by an interpreter.

Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Various embodiments, may be employed in a Lotus Notes environment, for example. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present disclosure based on the description herein with only a reasonable effort and without undue experimentation.

Various embodiments, of the systems and methods described herein may employ one or more electronic computer networks to promote communication among different components, transfer data, or to share resources and information. Such computer networks can be classified according to the hardware and software technology that is used to interconnect the devices in the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods, systems, and tools described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity.

Unless otherwise indicated, all numbers expressing lengths, widths, depths, or other dimensions and so forth used in the specification and claims are to be understood in all instances as indicating both the exact values as shown and as being modified by the term “about.” As used herein, the term “about” refers to a ±10% variation from the nominal value. Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques. Any specific value may vary by 20%.

The invention may be embodied in other specific forms without departing from the spirit or essential characteristics thereof. The foregoing embodiments are therefore to be considered in all respects illustrative rather than limiting on the disclosure described herein. Scope of the invention is thus indicated by the appended claims rather than by the foregoing description, and all changes which come within the meaning and range of equivalency of the claims are intended to be embraced therein.

It will be appreciated by those skilled in the art that various modifications and changes may be made without departing from the scope of the described technology. Such modifications and changes are intended to fall within the scope of the embodiments that are described. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

The use of headings and sections in the application is not meant to limit the disclosure; each section can apply to any aspect, embodiment, or feature of the disclosure. Only those claims which use the words “means for” are intended to be interpreted under 35 USC 112, sixth paragraph. Absent a recital of “means for” in the claims, such claims should not be construed under 35 USC 112. Limitations from the specification are not intended to be read into any claims, unless such limitations are expressly included in the claims.

Embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a computer program product embodied in one or more computer readable medium(s) having computer readable program code embodied thereon.

What is claimed is:

1. A computing system comprising:
a first input/output (IO) module;
a first computer system comprising
a first processor, a first memory, a first operating system, a first baseboard management controller (BMC), a first network controller; and
a management network comprising a set of network endpoints,
wherein each network endpoint has a first address, wherein each network endpoint is an internal device connected to the management network, wherein the first operating system is interfaced with the first BMC through a first interface supported by the first BMC.

2. The system of claim 1, wherein the first interface supported by the first BMC is a keyboard controller style (KCS) or Inter-Integrated Circuit (I2C) based Intelligent Platform Management Interface (IPMI), wherein each first address is a defined address.

3. The system of claim 1, wherein each first address is a media access control (MAC) address.

4. The system of claim 3, wherein each endpoint has a second address derived from the first address, wherein the second address is a link local address.

5. The system of claim 1, wherein each first address is a IPv6 link-local address.

6. The system of claim 1, wherein the first network controller, the first IO module, and the first BMC are each an internal device connected to the management network.

7. The system of claim 6 further comprising:
a second IO module; and
a second computer system comprising a second processor and a second memory, a second operating system, a second BMC, a second network controller, wherein the first computer system and the second computer system are linked by a sideband communication channel, wherein the sideband communication channel supports the first computer system and the second computer system exchanging one or more addresses.

8. The system of claim 7, wherein the second Ethernet controller, the second IO module, and the second BMC are each an internal device connected to the management network.

9. The system of claim 8, wherein each first address is a media access control (MAC) address.

10. The system of claim 8, wherein each first address is a IPv6 link-local address.

11. The system of claim 7, wherein the first operating system is interfaced with the first BMC through a first interface supported by the first BMC, wherein the second operating system is interfaced with the second BMC through a second interface supported by the second BMC.

12. The system of claim 11, wherein the first interface and the second interface are both KSC or I2C based IPMI interfaces.

13. The system of claim 7, wherein the one or more addresses is an address of the first computer system, the second computer system, or address of both the first computer system and the second computer system.

14. The system of claim 7, wherein the first operating system comprises a management virtual machine and a virtual switch, wherein the second operating system comprises a teaming interface, the teaming interface interfacing with one or more teamed connections and one or more non-teamed connections.

15. A method of allocating addresses in a self-configuring management network, the method comprising:
connecting a plurality of endpoints of a management network;
exchanging a first address between a first endpoint of the plurality of endpoints and a second endpoint of the plurality of endpoints;
determining a second address, the second address derivable from the first address, the second address associated with a first computer system; and
transmitting the second address to a second computer system using a sideband communication channel such that the second computer system can communicate with one or more devices of the first computer system.

16. The method of claim 15, wherein the first address is a MAC address and the second address is a IPv6 link-local address.

17. The method of claim 15, wherein the step of determining the second address comprises querying a BMC to obtain the first address and thereby deriving the second address.

18. The method of claim 17, wherein the BMC is queried by an operating system using a KCS or I2C based IPMI interface, the operating system running on one of the end points.

19. The method of claim 15, wherein determining the second address comprises accessing one or more scratchpad registers of one or more PCI switches and further comprising populating one or more scratchpad registers to exchange the first address for each endpoint of the plurality of endpoints using the sideband communication channel.

20. The method of claim 15, further comprising deriving a second address from each first address, wherein the first address is a MAC address and the second address is a IPv6 link-local address.

21. The method of claim 15, wherein configuring the plurality of endpoints is performed automatically without user configuration of any first addresses or second addresses.

22. The method of claim 15, wherein the sideband communication channel is a Peripheral Component Interconnect-based communication channel.
